(19) United States
(12) Patent Application Publication
(10) Pub. No.: US 2015/0138750 A1
(43) Pub. Date: May 21, 2015

(54) KEYBOARD

(71) Applicant: Wistron Corporation, New Taipei City (TW)

(72) Inventors: Su-Chen Yen, New Taipei City (TW); Wen-Hsiu Hung, New Taipei City (TW)

(73) Assignee: Wistron Corporation, New Taipei City (TW)

(21) Appl. No.: 14/228,260

(22) Filed: Mar. 28, 2014

(30) Foreign Application Priority Data
Nov. 15, 2013 (CN) 201310574310.X

(51) Int. Cl. H01H 13/83; F21V 8/00

(52) U.S. Cl. CPC H01H 13/83; G02B 6/0031; G02B 6/0073
USPC 362/23.03

(57) ABSTRACT

A keyboard includes a transparent board, keyswitches, and a backlight module. The keyswitches could move upward and downward relative to the transparent board. At least one keyswitch includes a cap and a light exciting layer disposed in a transparent concave portion of the cap. The backlight module is disposed under the transparent board and includes a blue-light emitting diode, a reflection sheet, and a light guide plate having a light entrance surface, a light exit surface, and a bottom surface. The blue-light emitting diode is disposed corresponding to the light entrance surface for emitting light into the light guide plate. The reflection sheet is disposed on the bottom surface for reflecting light in the light guide plate to emit out of the light exit surface and then pass through the transparent board and the transparent concave portion, so that the light exciting layer could be excited to emit light.

### BACKGROUND OF THE INVENTION

1. Field of the Invention

The present invention relates to a keyboard, and more specifically, to a keyboard with light emitting keyswitches.

2. Description of the Prior Art

A keyboard is an indispensable input apparatus for a personal computer to allow a user to input letters, symbols or numbers. As the personal computer is widely used in daily life, the visual design of the keyboard has also become an important issue. For example, a keyboard with light emitting keyswitches disposed thereon is one of the most representative examples.

The conventional light emitting design applied to the keyboard is to dispose a light source under each keyswitch and electrically connecting each keyswitch to a power switch of the light source. Accordingly, when a user presses the keyswitch to perform the input operation, the keyswitch could electrically conduct the power switch to make the light source emit light so as to achieve the purpose that the keyswitch could emit light. However, the aforesaid configuration not only makes the electrical conduction design of the keyswitch too complicated so as to be disadvantageous to the thinning design of the keyboard, but also cause the power consumption problem that the light source would be turned on or off frequently when the user presses the keyswitches many times to perform the input operation (e.g. the paperwork processing operation). Furthermore, when the user operates the keyboard in a dark environment, the aforesaid design could further cause the user much inconvenience in clearly viewing the positions of the keyswitches which has not been pressed to emit light.

### SUMMARY OF THE INVENTION

An objective of the present invention is to provide a keyboard with light emitting keyswitches, to solve the aforesaid problems.

The present invention provides a keyboard including a transparent board, a plurality of keyswitches, and a backlight module. The plurality of keyswitches is disposed on the transparent board and is movable upward and downward relative to the transparent board. At least one of the plurality of keyswitches includes a cap and a light exciting layer. The cap has a transparent concave portion. The light exciting layer is disposed in the transparent concave portion. The backlight module is disposed under the transparent board. The backlight module includes a light guide plate, at least one blue-light emitting diode, and a reflection sheet. The light guide plate has alight entrance surface, alight exit surface, and a bottom surface. The bottom surface is adjacent to the light entrance surface and opposite to the light exit surface. The at least one blue-light emitting diode is disposed at a position corresponding to the light entrance surface for emitting light into the light guide plate via the light entrance surface. The reflection sheet is disposed on the bottom surface of the light guide plate for reflecting light in the light guide plate to emit out of the light exit surface and then pass through the transparent board and the transparent concave portion to be incident into the light exciting layer, so that the light exciting layer could be excited to emit light.

According to the claimed invention, the light exciting layer includes a protection gel and a plurality of light exciting particles. The plurality of light exciting particles is doped into the protection gel.

According to the claimed invention, each light exciting particle is a quantum dot particle.

According to the claimed invention, a diameter of each light exciting particle is between 1 nm and 100 nm.

According to the claimed invention, the cap has a top surface and the transparent concave portion extends inwardly from the top surface of the cap.

According to the claimed invention, the keyswitch further includes a protection layer. The protection layer is disposed on the light exciting layer to protrude from the top surface or is contained in the transparent concave portion with the light exciting layer to align with the top surface.

According to the claimed invention, the protection layer is formed on the light exciting layer by a coating process or a printing process.

According to the claimed invention, the cap has a bottom surface and the transparent concave portion extends inwardly from the bottom surface of the cap.

According to the claimed invention, the keyswitch further includes a protection layer. The protection layer is disposed on the light exciting layer to protrude from the bottom surface or is contained in the transparent concave portion with the light exciting layer to align with the bottom surface.

According to the claimed invention, each light exciting particle is a phosphor.

According to the claimed invention, the transparent concave portion is formed on the cap by a laser engraving process or a chemical etching process.

According to the claimed invention, a bottom thickness of the transparent concave portion is between 10 μm and 1 mm.

According to the claimed invention, the transparent concave portion is a hollow out pattern.

In summary, the present invention adopts the design in which light emitted by the blue-light emitting diode passes through the light exciting layer disposed in the transparent concave portion of the cap, to make the light exciting layer excited to emit light, so as to achieve the purpose that the transparent concave portion of the cap could emit light. In such a manner, via the aforesaid simple design, the present invention could greatly simplify the light emitting design of the keyboard so as to be advantageous to the thinning design of the keyboard. Furthermore, since the light exciting layer could keep emitting light after being excited by light without frequently turning on or off the blue-light emitting diode, the present invention could effectively solve the power consumption problem and the problem that the user could not clearly view the positions of the keyswitches which has not been pressed to emit light when operating the keyboard in a dark environment.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a keyboard according to an embodiment of the present invention.

FIG. 2 is a partial sectional diagram of the keyboard in FIG. 1 along a sectional line X-X.

FIG. 3 is a partial sectional diagram of a keyboard according to another embodiment of the present invention.

### DETAILED DESCRIPTION

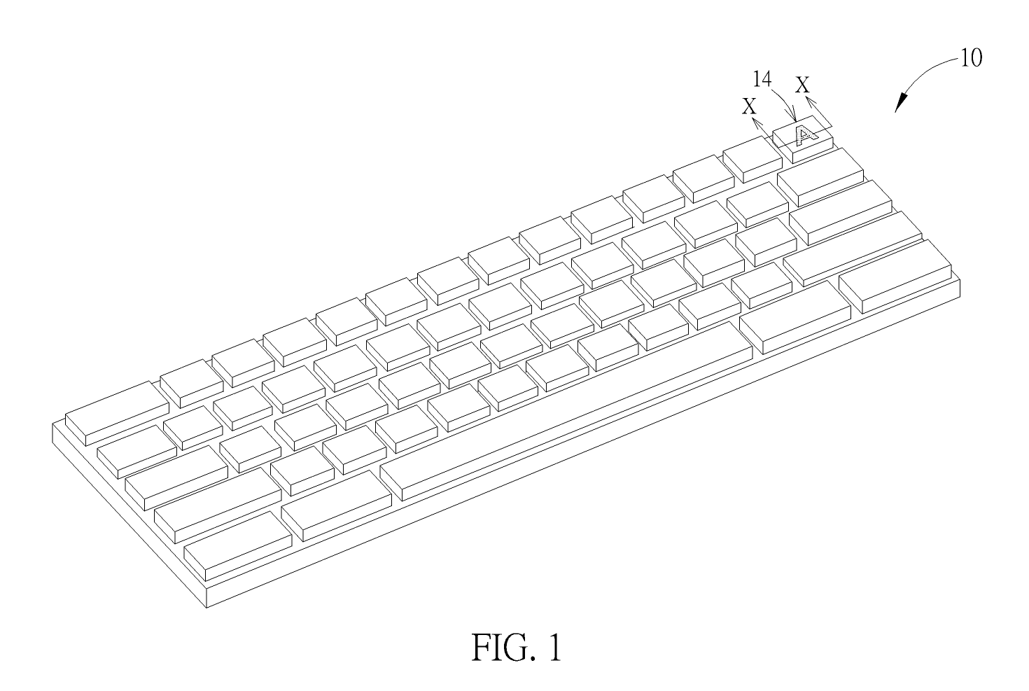

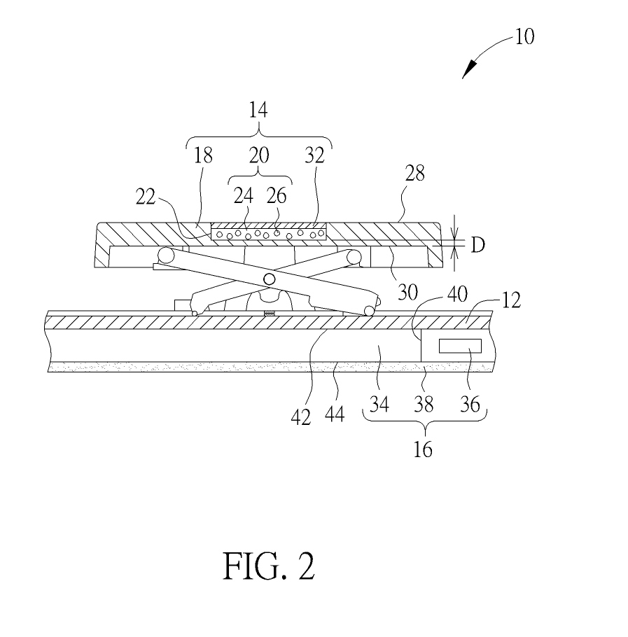

Please refer to FIG. 1 and FIG. 2. FIG. 1 is a schematic diagram of a keyboard 10 according to an embodiment of the present invention. FIG. 2 is a partial sectional diagram of the keyboard 10 in FIG. 1 along a sectional line X-X. As shown in FIG. 1 and FIG. 2, the keyboard 10 includes a transparent board 12, a plurality of keyswitches 14, and a backlight module 16. The keyswitches 14 could be disposed on the transparent board 12 and be movable upward and downward relative to the transparent board 12 for a user to perform the input operation. The design of the present invention in which a blue-light emitting diode is utilized to emit light for exciting a light exciting layer to emit light could be applied to at least one of the plurality of keyswitches 14. In the following, only one of the keyswitches 14 to which the aforesaid design is applied and the backlight module 16 are described in detail. As for the related description for other keyswitches 14 to which the aforesaid design is applied, it could be reasoned according to the following description.

Only the cap design of the keyswitch 14 is described herein. The related description for other keyswitch components (e.g. a scissor support mechanism, an elastic member, and a membrane) in FIG. 2 is omitted herein since it is commonly seen in the prior art. As shown in FIG. 2, the keyswitch 14 includes a cap 18 and a light exciting layer 20. The cap 18 has a transparent concave portion 22. The transparent concave portion 22 could be formed on the cap 18 preferably by a laser engraving process or a chemical etching process and could be a hollow out pattern (e.g. a letter or a symbol). A bottom thickness D of the transparent concave portion 22 is preferably between 10 μm and 1 mm for surely achieving the purpose that light could pass through the transparent concave portion 22. In this embodiment, the light exciting layer 20 is disposed in the transparent concave portion 22 and includes a protection gel 24 and a plurality of light exciting particles 26. The protection gel 24 could be made of anti-oxidation gel material, such as epoxy resin. Each light exciting particle 26 could be preferably a quantum dot particle and be doped into the protection gel 24, so as to form the light exciting layer 20 cooperatively with the protection gel 24. A diameter of the each quantum dot particle could be preferably between 1 nm and 100 nm. As for description for the light exciting principle of the quantum dot particle, it is commonly seen in the prior art and therefore omitted herein.

Furthermore, as shown in FIG. 2, the cap 18 has a top surface 28 and a bottom surface 30. The top surface 28 is opposite to the bottom surface 30. In this embodiment, the transparent concave portion 22 extends inwardly from the top surface 28 of the cap 18. The keyswitch 14 could further include a protection layer 32. The protection layer 32 could be disposed on the light exciting layer 20 preferably by a coating process, but not limited thereto, meaning that the protection layer 32 could also be formed by other surface forming process (e.g. a printing process). In such a manner, the protection layer 32 could provide an abrasion resistance function for preventing the light exciting layer 20 from being oxidized or wore down.

To be noted, as shown in FIG. 2, the protection layer 32 and the light exciting layer 20 could be contained in the transparent concave portion 22 to make the protection layer 32 align with the top surface 28. Accordingly, the protection layer 32 and the light exciting layer 20 could be hidden in the transparent concave portion 22 for reducing the probability of the protection layer 32 and the light exciting layer 20 being wore down, so that the abrasion resistance of the hollow out pattern formed on the keyswitch 14 could be greatly improved and life of the keyswitch 14 could be further prolonged. In another embodiment, the protection layer 32 could also be formed on the light exciting layer 20 and protrude from the top surface 28, so as to enhance the touch feeling of the keyswitch 14.

As shown in FIG. 2, the backlight module 16 is disposed under the transparent board 12 and includes a light guide plate 34, at least one blue-light emitting diode 36 (one shown in FIG. 2, but not limited thereto) and a reflection sheet 38. The light guide plate 34 has a light entrance surface 40, a light exit surface 42, and a bottom surface 44. The bottom surface 44 is adjacent to the light entrance surface 40 and opposite to the light exit surface 42. The blue-light emitting diode 36 is disposed at a position corresponding to the light entrance surface 40 for emitting light into the light guide plate 34 via the light entrance surface 40. The reflection sheet 38 is disposed on the bottom surface 44 for reflecting light in the light guide plate 34.

Via the aforesaid design, light emitted by the blue-light emitting diode 36 could be incident into the light guide plate 34 through the light entrance surface 40 and then be emitted out of the light exit surface 42 of the light guide plate 34 by the light guide design of the light guide plate 34 (e.g. a mesh layer structure formed on the bottom surface 44 of the light guide plate 34) and the reflection design of the reflection sheet 38. Finally, light could be incident into the light exciting layer 20 after passing through the transparent board 12 and the transparent concave portion 22 sequentially. In such a manner, the light exciting particles 26 (i.e. quantum dot particles) in the light exciting layer 20 could be excited by light to generate corresponding color light, so as to achieve the purpose that the transparent concave portion 22 of the keyswitch 14 could emit light. Accordingly, a user could view the hollow out pattern showed by the transparent concave portion 22 clearly and then perform the corresponding input operation correctly. In practical application, the color of the light generated by the quantum dot particle could vary with the diameter of the quantum dot particle. For example, the quantum dot particle with the diameter of 3 nm could be excited by blue light to generate green light, and the quantum dot particle with the diameter of 7 nm could be excited by blue light to generate red light. As for which color is adopted, it depend on the practical application of the present invention.

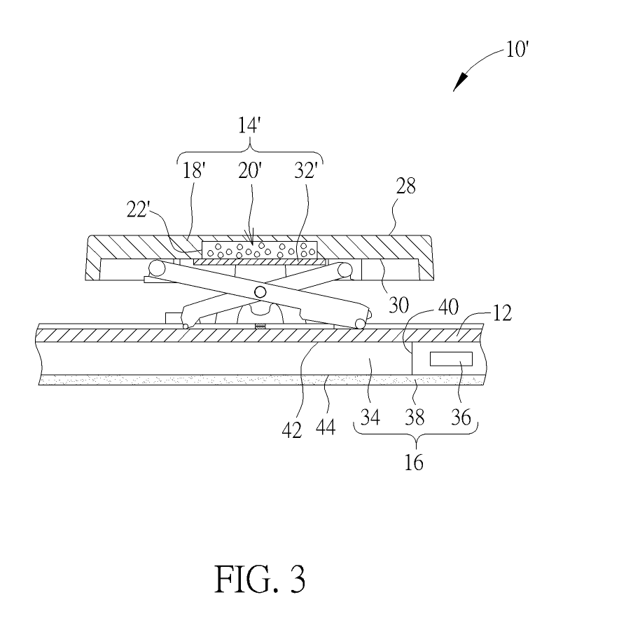

It should be mentioned that the light exciting design of the light exciting layer is not limited to the aforesaid embodiment. For example, in another embodiment, phosphors which could be excited by blue light, such as yellow phosphors or dual-color phosphors, could be doped into the protection gel to form the light exciting layer. Moreover, disposal of the light exciting layer and the transparent concave portion could also be not limited to the aforesaid embodiment. Please refer to FIG. 3, which is a partial sectional diagram of a keyboard 10′ according to another embodiment of the present invention. Components both mentioned in this embodiment and the aforesaid embodiment represent components with similar functions or structures, and the related description is omitted herein. The keyboard 10′ includes the transparent board 12, the backlight module 16, and a plurality of keyswitches 14′. The keyswitch 14′ includes a light exciting layer 20′, a cap 18′, and a protection layer 32′. The cap 18′ has a transparent concave portion 22′. In this embodiment, the transparent concave portion 22′ extends inwardly from the bottom surface 30 of the cap 18′, the light exciting layer 20′ is disposed in the transparent concave portion 22′, and the protection layer 32′ is disposed on the light exciting layer 20′ to protrude from the bottom surface 30. Accordingly, since the transparent concave portion 22′ is formed on the bottom surface 30 of the cap 18′ to replace the aforesaid design, the keyswitch 14′ could surely prevent the light exciting layer 20′ and the protection layer 32′ from being wore down, so as to further prolong life of the keyswitch 14′. As for description for the other related designs of the cap 18′, the light exciting layer 20′ and the protection layer 32′, it could be reasoned according to the aforesaid embodiment and therefore omitted herein.

Compared with the prior art, the present invention adopts the design in which light emitted by the blue-light emitting diode passes through the light exciting layer disposed in the transparent concave portion of the cap, to make the light exciting layer excited to emit light, so as to achieve the purpose that the transparent concave portion of the cap could emit light. In such a manner, via the aforesaid simple design, the present invention could greatly simplify the light emitting design of the keyboard so as to be advantageous to the thinning design of the keyboard. Furthermore, since the light exciting layer could keep emitting light after being excited by light without frequently turning on or off the blue-light emitting diode, the present invention could effectively solve the power consumption problem and the problem that the user could not clearly view the positions of the keyswitches which has not been pressed to emit light when operating the keyboard in a dark environment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A keyboard comprising:
a transparent board;
a plurality of keyswitches disposed on the transparent board and movable upward and downward relative to the transparent board, at least one of the plurality of keyswitches comprising:
a cap having a transparent concave portion; and
a light exciting layer disposed in the transparent concave portion; and
a backlight module disposed under the transparent board, the backlight module comprising:
a light guide plate having a light entrance surface, a light exit surface, and a bottom surface, the bottom surface being adjacent to the light entrance surface and opposite to the light exit surface;
at least one blue-light emitting diode disposed at a position corresponding to the light entrance surface for emitting light into the light guide plate via the light entrance surface; and
a reflection sheet disposed on the bottom surface of the light guide plate for reflecting light in the light guide plate to emit out of the light exit surface and then pass through the transparent board and the transparent concave portion to be incident into the light exciting layer, so that the light exciting layer could be excited to emit light.

2. The keyboard of claim 1, wherein the light exciting layer comprises:
a protection gel; and
a plurality of light exciting particles doped into the protection gel.

3. The keyboard of claim 2, wherein each light exciting particle is a quantum dot particle.

4. The keyboard of claim 3, wherein a diameter of each light exciting particle is between 1 nm and 100 nm.

5. The keyboard of claim 2, wherein the cap has a top surface, and the transparent concave portion extends inwardly from the top surface of the cap.

6. The keyboard of claim 5, wherein the keyswitch further comprises:
a protection layer disposed on the light exciting layer to protrude from the top surface or contained in the transparent concave portion with the light exciting layer to align with the top surface.

7. The keyboard of claim 6, wherein the protection layer is formed on the light exciting layer by a coating process or a printing process.

8. The keyboard of claim. 2, wherein the cap has a bottom surface, and the transparent concave portion extends inwardly from the bottom surface of the cap.

9. The keyboard of claim 8, wherein the keyswitch further comprises:
a protection layer disposed on the light exciting layer to protrude from the bottom surface or contained in the transparent concave portion with the light exciting layer to align with the bottom surface.

10. The keyboard of claim 9, wherein the protection layer is formed on the light exciting layer by a coating process or a printing process.

11. The keyboard of claim 2, wherein each light exciting particle is a phosphor.

12. The keyboard of claim 1, wherein the transparent concave portion is formed on the cap by a laser engraving process or a chemical etching process.

13. The keyboard of claim 1, wherein a bottom thickness of the transparent concave portion is between 10 μm and 1 mm.

14. The keyboard of claim 1, wherein the transparent concave portion is a hollow out pattern.
